(19) United States
(12) Patent Application Publication
(10) Pub. No.: US 2021/0200796 A1
(43) Pub. Date: Jul. 1, 2021

(54) SEARCH WORD SUGGESTION DEVICE, METHOD FOR GENERATING UNIQUE EXPRESSION INFORMATON, AND PROGRAM FOR GENERATING UNIQUE EXPRESSION INFORMATION

(71) Applicant: Nippon Telegraph and Telephone Corporation, Tokyo (JP)

(72) Inventors: Tsunenari Saito, Tokyo (JP); Yamato Harada, Tokyo (JP); Hiroshi Miyao, Tokyo (JP)

(21) Appl. No.: 17/052,338

(22) PCT Filed: May 20, 2019
(86) PCT No.: PCT/JP2019/019982

§ 371 Date: Nov. 2, 2020

(30) Foreign Application Priority Data
May 22, 2018 (JP) 2018-098019

(51) Int. Cl. G06F 16/332; G06K 9/00

(52) U.S. Cl. CPC G06F 16/3322; G06K 9/00463; G06K 9/00469

(57) ABSTRACT

A search word suggester extracts the column on left-hand end of table data, extracts a word arranged uppermost from words in the extracted column as the abstract word, and extracts words below the uppermost word in the extracted column as named entities for the abstract word. Then, the search word suggester generates abstract-word/named-entity data in which the extracted abstract word and the named entities for the extracted abstract word are associated with each other. Then, when the abstract word is input as a search word, the search word suggester refers to this abstract-word/named-entity data, and suggests a word as a result of combining the input search word with the named entity as a candidate of the search word to be used.

### TECHNICAL FIELD

The present invention relates to a search word suggester, a method for generating named entity information, and a program for generating named entity information.

### BACKGROUND ART

When looking for a document content with a search word, a user may fail to recall the specific name of the content and thus may fail to enter a specific name as the search word. For example, when a user who wants to search for a table related “UPAS office data” cannot recall the name of the table, he or she has no choice but to input an abstract word, such as “office data”, as the search word. This may result in listing documents unrelated to the content the user wants to know, and thus it may take a long time for the user to access the content he or she wants to know. However, the user can access the content he or she wants to see in a shorter period of time, if more specific words (named entities) can be presented in response to the input of a word that is abstract (abstract word) as the search word.

### CITATION LIST

### Patent Literature

PTL1: JP 5506482 B

PTL2: JP 5591870 B

### SUMMARY OF THE INVENTION

### Technical Problem

As a method for extracting a named entity for an abstract word, a method using supervised learning in natural language processing is mainly employed. Unfortunately, this method involves a problem that, for words not in the training data, a named entity might not be extractable due to the ambiguity of text analysis. In view of the above, an object of the present invention is to solve the problem described above, and extract a named entity for an abstract word without performing text analysis.

### Means for Solving the Problem

To solve the problem described above, the present embodiment includes: a column extraction unit that extracts a column on left-hand end of table data in a document; a named entity extraction unit that, from words in the extracted column, extracts a word arranged uppermost as an abstract word and extracts a word below the uppermost word as a named entity for the extracted abstract word; and an information generation unit that generates named entity information in which the extracted abstract word and the named entity for the extracted abstract word are associated with each other.

### Effects of the Invention

According to an embodiment of the present invention, a named entity for an abstract word can be extracted without performing text analysis.

### BRIEF DESCRIPTION OF DRAWINGS

FIG. 1 is a diagram illustrating an example of an operation performed by a search word suggester according to a first embodiment.

FIG. 2 is a diagram illustrating an example of a configuration of the search word suggester according to the first embodiment.

FIG. 3 is a flowchart illustrating an example of a procedure in which the search word suggester according to the first embodiment generates abstract-word/named-entity data.

FIG. 4 is a flowchart illustrating an example of a procedure in which a first search word suggester suggests a search word.

FIG. 5 is a diagram illustrating an example of an operation performed by a search word suggester according to a second embodiment.

FIG. 6 is a flowchart illustrating an example of a procedure in which the search word suggester according to the second embodiment generates abstract-word/named-entity data.

FIG. 7 is a diagram illustrating a computer that executes a control program.

### DESCRIPTION OF EMBODIMENTS

Hereinafter, modes for carrying out the present disclosure (hereinafter, referred to as “embodiments”) will be described with reference to the drawings. The embodiments include a first embodiment and a second embodiment separately described. The present invention is not limited to the embodiments.

### First Embodiment

### Overview

A search word suggester according to a first embodiment suggests search word candidates that can be used for data searching. The candidates are words as a result of adding words (named entities) that more specifically represent a search word input from a user. Thus, even when the user fails to come up with a word that more specifically represents the content he or she wants to know, the user can access the content he or she wants to know with a shorter period of time.

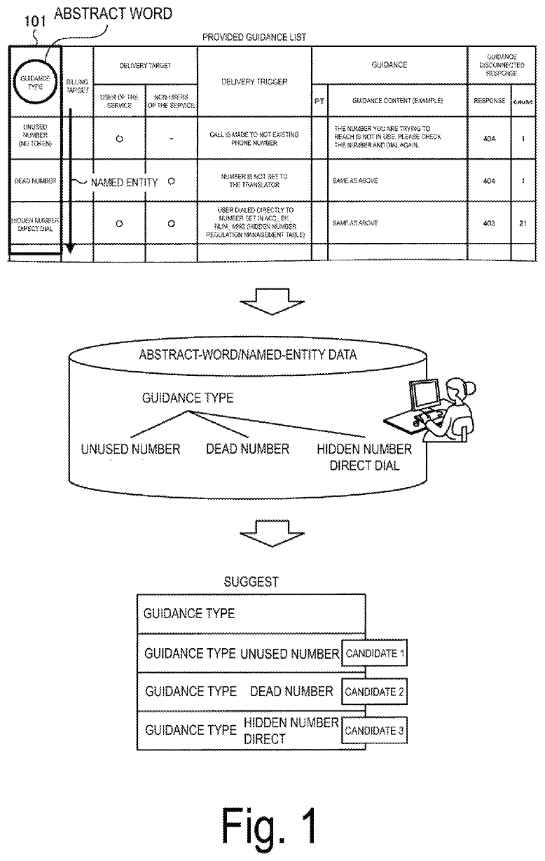

Generally, in many cases, the column on left-hand end of a table (table data) in a document is a column with the main item of the contents of the table. In many cases, the column indicating the main item includes a pair of an abstract word and a named entity for the abstract word. For example, the column (column 101) on left-hand end of a table “provided guidance list” in FIG. 1 is a column with the main item in this table. The leftmost column includes words such as guidance type, unused number, dead number, and hidden number dial arranged in this order from the above. Among these words, the word “guidance type” arranged uppermost and each word therebelow (such as “unused number”, “dead number”, or “hidden number dial”) have a relationship between an abstract word and a named entity for the abstract word.

On the basis of such a feature, the search word suggester extracts the word arranged uppermost from the words in the column on left-hand end of the table as the abstract word, and extracts the words below the uppermost word as the named entities for the abstract word. The search word suggester then generates abstract-word/named-entity data (named entity information) in which the named entity and the named entity extracted are associated with each other. Then, when the abstract word registered in the abstract-word/named-entity data is input as a search word, the search word suggester suggests as a candidate for the search word, a word as a result of combining the abstract word with the named entity for the abstract word.

A case is described as an example where a word “guidance type” is input to the search word suggester as a search word. As illustrated in FIG. 1, the search word suggester suggests as a candidates for the search word (candidates 1 to 3), words provided as a result of combining the “guidance type” with the corresponding named entities (such as “unused number”, “dead number”, and“hidden number”) in the abstract-word/named-entity data.

Thus, even when the user fails to come up with a word (such as “unused number”, “dead number”, and “hidden number direct”) that indicates a detail of the content (such as “guidance type”) he or she wants to know, the user can find the word indicating the detail of the target content from the suggested list of search word candidates. Then, an information search device performs information search using the search word selected by the user, so that a content close to what the user wants to know can be output as a search result. As a result, the user can access the content he or she wants to know in a shorter period of time.

The search word suggester 10 uses the words in the column on left-hand end of the table that is likely to include a pair of an abstract word and a named entity for the abstract word, to generate the abstract-word/named-entity data. Thus, a named entity for an abstract word can be more easily extracted compared with a case where text analysis or the like is performed.

Configuration

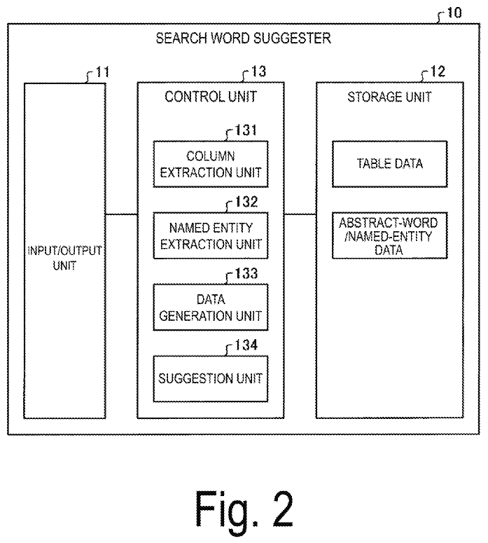

Next, a configuration of the search word suggester 10 will be described with reference to FIG. 2. The search word suggester 10 includes an input/output unit (input unit and output unit) 11, a storage unit 12, and a control unit 13. The input/output unit 11 serves as an input/output interface of the search word suggester 10. For example, the input/output unit 11 receives a search word input from the user and outputs a suggestion result for the search word (search word candidate).

The storage unit 12 stores various types of information for the control unit 13 to suggest the search word. For example, the storage unit 12 stores one or more pieces of table data. The storage unit 12 includes a region for storing the abstract-word/named-entity data output from the control unit 13.

The control unit 13 includes a column extraction unit 131, a named entity extraction unit 132, a data generation unit 133, and a suggestion unit 134.

The column extraction unit 131 extracts, from the table data, a column indicating a main item of the contents of the table data. For example, the column extraction unit 131 extracts the column on left-hand end of the table data (table) from the table data in the storage unit 12. The column extraction unit 131 may extract a column on the right side of and adjacent to the column on left-hand end of the table data, if the column on left-hand end of the table data is a column indicating the item number or includes character strings without meaning such as “∘”, “-” and “same as above”. This configuration enables the column extraction unit 131 to more easily and reliably extract the column indicating the main item of the content of the table data.

The named entity extraction unit 132 extracts, among words in the column (the column on left-hand end of the table, for example) extracted by the column extraction unit 131, the word arranged uppermost in the column as the abstract word, and extracts words below the uppermost word in the column as the named entities for the abstract word. For example, the named entity extraction unit 132 extracts “guidance type”, arranged uppermost in the column on left-hand end of the table illustrated in FIG. 1 as the abstract word, and extracts “unused number”, “dead number”, and “hidden number direct”, below “guidance type” in the column, as the named entities for “guidance type”.

The data generation unit 133 generates the abstract-word/named-entity data (named entity information) in which the abstract word and the named entity extracted by the named entity extraction unit 132 are associated with each other. For example, as illustrated in FIG. 1, the data generation unit 133 generates abstract-word/named-entity data in which “unused number”, “dead number”, and “hidden number direct” are associated, as named entities, with the abstract word “guidance type”, and stores the abstract-word/named-entity data in the storage unit 12.

The suggestion unit 134 suggests a search word to the user. Specifically, when the user inputs, as a search word, the abstract word included in the abstract-word/named-entity data to the suggestion unit 134 via the input/output unit 11 after the abstract-word/named-entity data has been generated by the data generation unit 133, the suggestion unit 134 suggests a word as a result of combining the search word with the corresponding named entity from the abstract-word/named-entity data, as a candidate for a search word to be used for the search.

For example, when the word “guidance type” is input as the search word to the suggestion unit 134, the suggestion unit 134 suggests candidates of a word to be used for the search (candidates 1 to 3) as a result of combining the word “guidance type” with each of the words (such as unused number, dead number, and hidden number direct) that are the named entities for “guidance type” in the abstract-word/named-entity data (see FIG. 1). Note that the suggested candidates for the search word are displayed, for example, in an area such as an area below the screen region where the user has entered the search word. Then, the user performs input for selecting the search word to be used for the search from the search words displayed on the screen and the search words suggested. Then, the search word suggester 10 or the information search device (not illustrated) performs information search using the search word selected by the user.

Processing Procedure

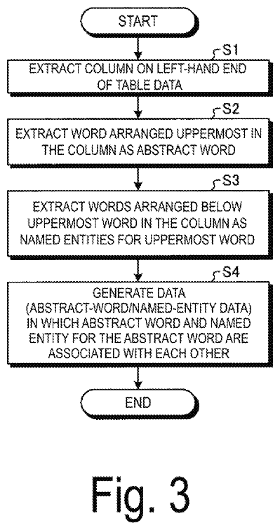

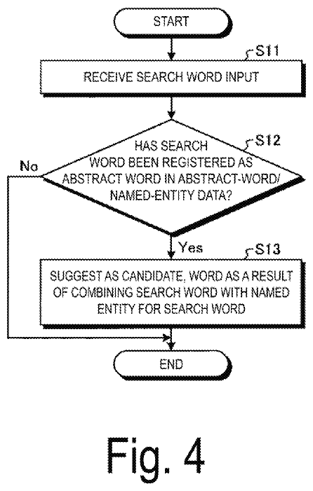

Next, a procedure of processing executed by the search word suggester 10 will be described. First of all, an example of a procedure in which the search word suggester 10 generates the abstract-word/named-entity data will be described with reference to FIG. 3. Then, an example of a procedure in which the search word suggester 10 suggests the search word by using the abstract-word/named-entity data will be described with reference to FIG. 4. Note that a case is described as an example in which the search word suggester 10 extracts the column on left-hand end of the table as the column indicating the main item of the contents of the table data (table).

For example, the column extraction unit 131 of the search word suggester 10 extracts the column on left-hand end of the table data (table) from the table data in the storage unit 12 (S1). Next, the named entity extraction unit 132 extracts the word arranged uppermost in the column as the abstract word (S2). The named entity extraction unit 132 further extracts the words below the uppermost word in the column as the named entities for the uppermost word (S3). Then, the data generation unit 133 generates data in which the extracted abstract word and the named entities for the abstract word are associated with each other (abstract-word/named-entity data) (S4). Then, the data generation unit 133 stores the generated abstract-word/named-entity data in the storage unit 12. In this manner, the search word suggester 10 can generate the abstract-word/named-entity data.

The description will now be given with reference to FIG. 4. The input/output unit 11 of the search word suggester 10 receives the search word input (S11). When the search word input has been registered as the abstract word in the abstract-word/named-entity data (Yes in S12), the suggestion unit 134 reads out the named entities for the search word in the abstract-word/named-entity data. Then, the suggestion unit 134 suggests, as search word candidates, the words as a result of combining the search word with the named entities for the search word (S13). On the other hand, when the search word input has not been registered as the abstract word in the abstract-word/named-entity data (No in S12), the suggestion unit 134 does not execute the S13 processing.

Thus, even when the user fails to come up with a word (such as “unused number”, “dead number”, and “hidden number direct”) that indicates a detail of the content (“guidance type”, for example) he or she wants to know, the search word suggester 10 can suggest, as the candidates for the search word, the words as a result of combining the abstract word with each of the words indicating the detail of the content (such as “unused number”, “dead number”, and “hidden number direct”).

### Second Embodiment

Next, a second embodiment of the present invention will be described. Configurations that are the same as those in the first embodiment are denoted with the same reference signs, and the description thereof will be omitted. The column extraction unit 131 of the search word suggester 10 according to the second embodiment extracts, as the column indicating the main item of the contents of the table data (table), a column with the word arranged uppermost including a character string of the title of the table, from the table.

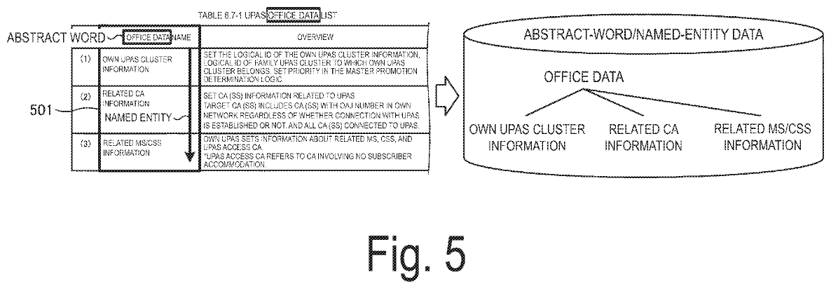

For example, as illustrated in FIG. 5, the column extraction unit 131 acquires the table data (table) with the title “** list” (for example “UPAS office data list”). Then, the column extraction unit 131 extracts, from the table acquired, a column (column 501) with the word arranged uppermost (for example, “office data name”) including a character string (for example, “office data”) included in the title.

Then, as in the first embodiment, the named entity extraction unit 132 extracts, among words in the column extracted by the column extraction unit 131, the word arranged uppermost in the column as the abstract word, and extracts words below the uppermost word in the column as the named entities for the abstract word.

For example, the named entity extraction unit 132 extracts as the abstract word, “office data”, which is arranged uppermost, among the words in the column 501 of FIG. 5, and extracts as the named entities, “own UPAS cluster information”. “related CA information”, and “related MS-CSS information” arranged below “office data (office data name)”. Then, the data generation unit 133 generates the abstract-word/named-entity data in which “own UPAS cluster information”, “related CA information”, and “related MS-CSS information” are associated, as named entities, with the abstract word “office data (office data name)” and stores the data in the storage unit 12. Then, the suggestion unit 134 uses the created abstract-word/named-entity data to suggest search word candidates to the user.

Processing Procedure

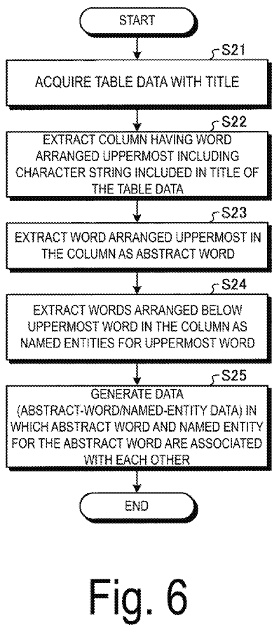

Next, an example of a procedure in which the second search word suggester 10 generates the abstract-word/named-entity data will be described with reference to FIG. 6. First of all, the column extraction unit 131 of the search word suggester 10 acquires table data with a title from the storage unit 12 (S21). Then, the column extraction unit 131 extracts a column having the word arranged uppermost including a character string included in the title of the table data (S22). The processing in S23 to S25 is the same as the processing in S2 to S4 in FIG. 4, and thus the description thereof is omitted.

Such a search word suggester 10 uses the words in the column having the word arranged uppermost including a character string of the title of the table, among the columns in the table, to generate the abstract-word/named-entity data. Thus, the named entities for the abstract word can be more easily extracted, compared with the case where the text analysis or the like is performed.

Program

A program that enables the functions of the search word suggester 10 described in the embodiments described above can be implemented by installing the program on a desired information processing device (computer). For example, an information processing device can function as the search word suggester 10, with the program, provided as package software or online software, executed by the information processing device. The information processing device described here includes a desktop or laptop personal computer. Furthermore, the information processing device includes a mobile communication terminal such as a smart phone, a mobile phone, and a Personal Handyphone System (PHS), as well as Personal Digital Assistant (PDA). The search word suggester 10 can also be implemented on a cloud server.

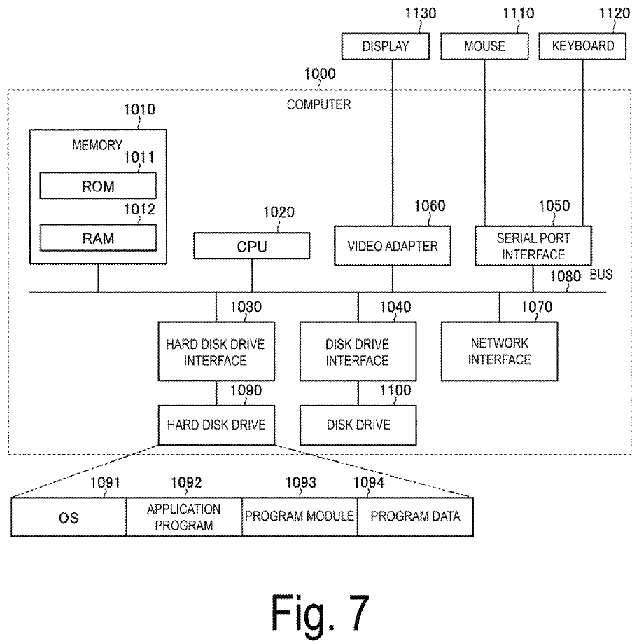

An example of a computer that executes the program (control program) described above will be described with reference to FIG. 7. As illustrated in FIG. 7, a computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes Read Only Memory (ROM) 1011 and a Random Access Memory (RAM) 1012. The ROM 1011 stores a boot program, such as Basic Input Output System (BIOS). The hard disk drive interface 1030 is connected to a hard disk drive 1090. The disk drive interface 1040 is connected to a disk drive 1100. A removable storage medium, such as a magnetic disk or an optical disk for example, is inserted into the disk drive 1100. A mouse 1110 and a keyboard 1120, for example, are connected to the serial port interface 1050. A display 1130, for example, is connected to the video adapter 1060.

Here, the hard disk drive 1090 stores, for example, an OS 1091, an application program 1092, a program module 1093, and program data 1094 as illustrated in FIG. 7. The various types of data and information described in the aforementioned embodiments are stored in, for example, the hard disk drive 1090 and the memory 1010.

The CPU 1020 loads the program module 1093 and the program data 1094, stored in the hard disk drive 1090, onto the RAM 1012 as appropriate, and executes each of the aforementioned procedures.

The program module 1093 or the program data 1094 related to the control program described above is not limited to the case where they are stored in the hard disk drive 1090. For example, the program module 1093 or the program data 1094 may be stored in a removable storage medium and read out by the CPU 1020 via the disk drive 1100 or the like. Alternatively, the program module 1093 or the program data 1094 related to the communication program may be stored in another computer connected via a network such as a local area network (LAN) or a wide area network (WAN), and read by the CPU 1020 via the network interface 1070.

### REFERENCE SIGNS LIST

10 Search word suggester
11 Input/output unit
12 Storage unit
13 Control unit
131 Column extraction unit
132 Named entity extraction unit
133 Data generation unit
134 Suggestion unit

1. A search word suggester comprising:
a column extraction unit, including one or more processors, configured to extract a column on left-hand end of table data in a document;
a named entity extraction unit, including one or more processors, configured to extract, from words in the extracted column, a word arranged uppermost as an abstract word and extract, from the words in the extracted column, a word below the uppermost word as a named entity for the extracted abstract word; and
an information generation unit, including one or more processors, configured to generate named entity information in which the extracted abstract word and the named entity for the extracted abstract word are associated with each other.

2. The search word suggester according to claim 1, wherein when the column on left-hand end of the table data is a column indicating an item number, the column extraction unit extracts a column that is on right side of and is adjacent to the column indicating the item number.

3. The search word suggester according to claim 1, wherein:
the column extraction unit is further configured to extract a column from table data with a title, among table data in a document, the column having a word arranged uppermost including a character string of the title of the table data.

4. The search word suggester according to claim 1, further comprising a suggestion unit, including one or more processors, configured to refer to the named entity information, when the abstract word included in the named entity information is input as a search word, to read out, as a candidate of the search word, the named entity corresponding to the input search word, and suggests a word as a result of combining the input search word with the named entity.

5. A method of generating named entity information performed by a search word suggester, the method comprising:
extracting a column on left-hand end of table data in a document;
extracting, from words in the extracted column, a word arranged uppermost as an abstract word and extracting, from the words in the extracted column, a word below the uppermost word as a named entity for the extracted abstract word; and
generating named entity information in which the extracted abstract word and the named entity for the extracted abstract word are associated with each other.

6. A non-transitory computer readable medium storing one or more instructions causing a computer to execute:
extracting a column on left-hand end of table data in a document;
extracting, from words in the extracted column, a word arranged uppermost as an abstract word and extracting, from the words in the extracted column, a word below the uppermost word as a named entity for the extracted abstract word; and
generating named entity information in which the extracted abstract word and the named entity for the extracted abstract word are associated with each other.

7. The method according to claim 5, further comprising:
when the column on left-hand end of the table data is a column indicating an item number, extracting a column that is on right side of and is adjacent to the column indicating the item number.

8. The method according to claim 5, further comprising:
extracting a column from table data with a title, among table data in a document, the column having a word arranged uppermost including a character string of the title of the table data.

9. The method according to claim 5, further comprising:
referring to the named entity information, when the abstract word included in the named entity information is input as a search word, to read out, as a candidate of the search word, the named entity corresponding to the input search word, and suggests a word as a result of combining the input search word with the named entity.

10. The non-transitory computer readable medium according to claim 6, wherein the one or more instructions further comprise:
when the column on left-hand end of the table data is a column indicating an item number, extracting a column that is on right side of and is adjacent to the column indicating the item number.

11. The non-transitory computer readable medium according to claim 6, wherein the one or more instructions further comprise:
extracting a column from table data with a title, among table data in a document, the column having a word arranged uppermost including a character string of the title of the table data.

12. The non-transitory computer readable medium according to claim 6, wherein the one or more instructions further comprise:
referring to the named entity information, when the abstract word included in the named entity information is input as a search word, to read out, as a candidate of the search word, the named entity corresponding to the input search word, and suggests a word as a result of combining the input search word with the named entity.
